(19) United States
(12) Patent Application Publication
(10) Pub. No.: US 2014/0024735 A1
(43) Pub. Date: Jan. 23, 2014

(54) METHOD FOR PREPARING CROSS-LINKED BITUMEN/POLYMER COMPOSITIONS BY MEANS OF ELECTROMAGNETIC WAVE RADIATION

(71) Applicants: Sylvia Harders, Buchholz (DE); Julien Chaminand, Vaulx en Velin (FR); David Vuillot, Saint Maurice De Beynost (FR); Jean-François Rochas, Caluire et Cuire (FR)

(72) Inventors: Sylvia Harders, Buchholz (DE); Julien Chaminand, Vaulx en Velin (FR); David Vuillot, Saint Maurice De Beynost (FR); Jean-François Rochas, Caluire et Cuire (FR)

(73) Assignee: TOTAL MARKETING SERVICES, Puteaux (FR)

(21) Appl. No.: 13/983,927

(22) PCT Filed: Feb. 8, 2012
(86) PCT No.: PCT/EP2012/052079

§ 371 Date: Oct. 10, 2013

(30) Foreign Application Priority Data
Feb. 9, 2011 (FR) 1151054

(51) Int. Cl. C08L 95/00

(52) U.S. Cl. CPC C08L 95/00
USPC 522/73; 524/71

(57) ABSTRACT

The disclosure includes a process for preparing cross-linked bitumen/polymer compositions without adding a cross-linking agent, the process comprising contacting at least one bitumen with at least one polymer, and subjecting a mixture of the bitumen and the polymer to electromagnetic wave radiation in a high frequency and/or microwave range.

### CROSS-REFERENCE TO RELATED APPLICATIONS

This application is a National Phase Entry of International Application No. PCT/EP2012/052079, filed on Feb. 8, 2012, which claims priority to French Patent Application Serial No. 11 51 054, filed on Feb. 9, 2011, both of which are incorporated by reference herein.

### TECHNICAL FIELD

The present invention belongs to the field of bitumen, in particular to the field of bitumen/polymer mixtures or compositions. The present invention relates to a process for the preparation of bitumen/polymer compositions or mixtures cross-linked by electromagnetic wave radiation. The present invention also relates to the cross-linked bitumen/polymer compositions or mixtures capable of being obtained by said process. Moreover, the invention relates to the use of this radiation via electromagnetic waves for cross-linking the bitumen/polymer compositions or mixtures. Finally, the invention relates to the cross-linked bitumen/polymer compositions capable of being obtained by the process of the invention, these compositions being able to be diluted in other bitumen and/or mixed with aggregates in order to form bituminous mixes and/or bituminous mastics for industrial membranes.

### BACKGROUND

The use of bitumen in the manufacture of materials for highway and industrial applications has been known for a long time: bitumen is the main hydrocarbon binder used in the field of road construction or civil engineering. To be able to be used as a binder in these different applications, a bitumen must have certain chemical, physical and mechanical properties. It is well known that the properties of pure bitumen can be modified by the addition of polymers. There can be mentioned for example, the addition of copolymers of aromatic monovinyl and conjugated diene, such as the copolymers of styrene and butadiene. It is also well known that the resistance to mechanical and thermal stresses, the rheological, elastic and mechanical performances of the bitumen/polymer compositions, are clearly improved when the polymers of aromatic monovinyl and conjugated diene, such as the copolymers of styrene and butadiene, are cross-linked using sulphur-based cross-linking agents.

During the preparation of the bitumen/polymer compositions cross-linked with sulphur, the addition of sulphur can lead to emissions of hydrogen sulphide (also called H₂S). Hydrogen sulphide is a colourless and fairly toxic gas, having moreover a characteristic odour at very low concentrations. The hydrogen sulphide emissions can therefore be a nuisance in particular to those preparing the cross-linked bitumen/polymer compositions using sulphur based cross-linking agents. It would therefore be desirable, in particular for the comfort and safety of workers, to find an alternative process for the preparation of cross-linked bitumen/polymer compositions, which does not use sulphur-based cross-linking agents.

It has been proposed in application FR-A-2948677, to use particular polymers of aromatic monovinyl and conjugated diene, comprising a large quantity of 1,2 double bond units originating from the conjugated diene and to thermally cross-link these polymers without an external supply of sulphur. The use of these polymers has made it possible to obtain cross-linked bitumen/polymer compositions without emissions of hydrogen sulphide. However, as this involves a fairly long reaction time of the order of 8 to 24 hours, a need exists for a process for the preparation of cross-linked bitumen/polymer compositions not having emissions of hydrogen sulphide which is quicker.

In WO2005021654, the cross-linking of a polymer composition without an organic component, therefore without bitumen, intended to cover damaged surfaces and more particularly damaged roads, is described. In this application two methods of cross-linking the polymer are proposed, the chemical route in the presence of a cross-linking agent and the use of a microwave type electromagnetic radiation. According to an embodiment the powder constituting the polymer composition, optionally in the presence of fillers such as sand, grit or fine gravel, is spread thinly then radiation is applied for in situ cross-linking for example on the road itself.

### SUMMARY

In these circumstances, the purpose of the present invention is to propose a novel process for cross-linking polymers dispersed in a bitumen not requiring the addition of cross-linking agent, and making it possible to obtain cross-linked bitumen/polymer compositions which have enhanced mechanical and rheological properties, in particular as regards their consistency, and/or their thermal susceptibility, and/or their elastic recovery and/or their properties as regards traction and/or their cohesion and/or their rigidity according to the Superpave specifications and/or their storage stability. Other characteristics such as resistance to aging or to hydrocarbons, the low-temperature behaviour will also be able to improve. Similarly, for the mixes obtained from the cross-linked bitumen/polymer compositions according to the invention, the objective is to improve their behaviour as regards fatigue and/or their resistance to rutting and/or their resistance to thermal cracking.

The applicant company has developed a novel process for cross-linking bitumen/polymer compositions in the absence of any cross-linking agent using electromagnetic wave radiation which allows to accelerate the cross-linking of the bitumen/polymer compositions, and consequently in the absence of any type of gas emissions which are harmful for the environment and in particular hydrogen sulphide. The use of a high frequency and/or microwave radiation, promotes the reduction in cross-linking time compared with standard thermal heating, the overall cross-linking time therefore being very much shorter. The process according to the invention compared to thermal processes usually used has a double effect promoting the acceleration of the cross-linking. It allows the acceleration of the cross-linking reaction under the action of the “electric field” component of an electromagnetic wave applied to the material to be treated, optionally associated with heating the reaction medium.

It is the amplitude of the electromagnetic field applied which will promote the acceleration of the cross-linking reaction, the subsequent heating induced by the application of this field being an independent phenomenon of the previous one and sometimes an inconvenience when the degradation temperature of the products is reached. The process according to the invention is such that the intensity of the electromagnetic wave field can be adjusted, thus allowing to control the temperature of the reaction medium, this temperature having to be limited in order to avoid the cracking of said composition. The process according to the invention promotes the obtaining of bitumen/polymer compositions less sensitive to aging due to the reduction in the cross-linking time.

A subject of the invention is a process for the preparation of cross-linked bitumen/polymer compositions without the addition of cross-linking agent, in which at least one bitumen and at least one polymer are contacted, the mixture of said bitumen and said polymer being subjected to an electromagnetic wave radiation in the high frequency and/or microwave range. The process according to the invention is such that the frequencies of the electromagnetic waves are comprised between 1 MHz and 300 GHz. In the process according to the invention, the bitumen/polymer mixture is cross-linked at a temperature less than or equal to 240° C. Preferably, according to the process, the bitumen/polymer mixture is cross-linked in the liquid phase at a temperature greater than or equal to 90° C. In a preferred embodiment of the process, the bitumen/polymer mixture is cross-linked at a temperature varying from 120° C. to 220° C.

For the effective implementation of the process, this latter will comprise at least one step of mixing the bitumen with said polymer and at least one step of subjecting the mixture to a radiation by electromagnetic waves. Preferably, in the process of the invention, the bitumen/polymer mixture is obtained at ambient temperature by grinding the two components respectively then intimately mixing of them. In order to facilitate this mixing step of the process according to the invention, the bitumen is heated to a temperature at least equal to 90° C. by any means, then the polymer is introduced in divided form into said bitumen.

In the second step of the process, the bitumen/polymer mixture is subjected to electromagnetic radiation for a duration at most four times less than the cross-linking time by thermal heating for the same bitumen/polymer mixture, preferably at most six times. In a preferred embodiment of the process, the bitumen/polymer mixture is subjected to an electromagnetic radiation for a duration of less than 6 hours.

Preferably, the polymer to be cross-linked is a polymer based on units comprising unsaturations, in particular double bonds, preferably conjugated double bonds including conjugated diene units. Among the polymers known for use in bitumen, the polymer is chosen from the aromatic monovinyl hydrocarbon and conjugated diene copolymers, the alkylenes and/or aromatic mono or polyvinyl hydrocarbon terpolymers, the mono, polycarboxylate and/or alkylmono, polycarboxylates copolymers, the alkylene and carboxylic anhydride copolymers, the conjugated diene polymers and the alkylene/carboxylate/aromatic vinyl terpolymers, these compounds being used alone or in a mixture. Among the polymers, a polymer based on styrene units and butadiene units is preferred, the diene unit content being greater than or equal to 5% by mass, preferably greater than 15% by mass, with respect to the total mass of the conjugated diene units. Preferably, the quantity of polymer in the bitumen/polymer mixture to be cross-linked according to the invention, is chosen comprised between 0.1% and 30% by mass, with respect to the mass of the bitumen/polymer composition, preferably between 0.5% and 20%, more preferably between 1% and 10%, even more preferably between 2% and 9%, even more preferably between 3% and 5%.

A second subject of the present invention is the cross-linked bitumen/polymer composition capable of being obtained by the process, optionally in a mixture with at least one other bitumen. A third subject of the present invention is the bituminous mix comprising aggregates and a cross-linked bitumen/polymer composition, optionally in a mixture with at least one other bitumen. A fourth subject of the present invention is the bituminous mastic comprising fillers and a bitumen/polymer composition, optionally in a mixture with at least one other bitumen. A fifth subject of the present invention is the use of an electromagnetic wave radiation in the high frequency and/or microwave range for cross-linking without the outside addition of a cross-linking agent a bitumen/polymer composition comprising at least one bitumen and at least one polymer.

### DETAILED DESCRIPTION

The invention relates to a process for the preparation of cross-linked bitumen/polymer compositions, in the absence of cross-linking agent, without an outside supply of cross-linking agent. By “in the absence of cross-linking agent” or “without an outside supply of cross-linking agent”, is meant a process in which no cross-linking agent is added. However, the cross-linking agent naturally present in the bitumen in the case of sulphur-containing derivatives, can be present in the form of traces or impurities, for example in a quantity less than 0.01% by mass, with respect to the mass of the bitumen/polymer composition, and even less than 0.001% by mass. Such traces or impurities could also originate from contamination by the use of reactors or pipelines having previously been used for other mixtures containing a cross-linking agent added intentionally.

Radiation by Electromagnetic Waves

In the present invention, the composition to be cross-linked is subjected to electromagnetic wave radiation constituted by a sinusoidal electric field coupled to a sinusoidal magnetic field of similar frequency. The interaction of the wave with the “athermal” matter allows the acceleration of the cross-linking by application at a given wavelength and a given frequency. However, it is accompanied by heating of the composition by acting on the polar molecules present in said composition.

In the electromagnetic spectrum, electromagnetic waves exist over a very broad range of frequencies situated between 1 Hz and 300 GHz but the use of virtually all of the frequencies is reserved and required for telecommunication uses i.e. information exchange, for example and non-exhaustively, radio, television, mobile phones or also radars. The world is divided in three regions defined by the ITU (International Telecommunication Union) without radiation limits for industrial, scientific and medical applications, these bands being called ISM bands. In Europe, the standard EN 55011 enforces the bands which are available for the industrial, scientific and medical use of such waves.

However, outside the ISM bands, these waves can be used for industrial, scientific and medical applications as the electromagnetic radiation of the machines towards the outside is less than the level of radiation laid down by the ITU, for example less than −40 dB microvolt per metre, 30 m from the equipment for a frequency of 915 MHZ. The radiation limit laid down by the ITU is not identical over the entire range of frequencies. Among the available frequencies, those used in the process according to the invention are waves in the high frequency and/or the microwave range. These electromagnetic waves preferably correspond to ISM frequencies of the frequency spectrum extending from 1 MHz to 300 GHz. If in the future other wavelengths become accessible for industrial applications such as that of the present invention the scope of the invention will not be exceeded.

The electromagnetic waves corresponding to the high frequency vary from 1 MHz to 300 MHz and those corresponding to microwaves vary from 300 MHz to 300 GHz. Frequencies which can be used according to the process are for example the following frequencies: 6.78 MHz, 13.56 MHz, 27.12 MHz, 40.68 MHz, 433.92 MHz, 915 MHz, or 2450 MHz, 5800 MHz, 24125 MHz, 61250 MHz, 122500 MHz, 245000 MHz. These frequencies are standard frequencies, created by generators equipped with existing vacuum tubes (triodes, pinthodes, magnetrons, Klystrons, travelling-wave tubes or transistors) and standard and existing industrial applicators.

In order to implement the process according to the invention two types of commercially available devices are used, specific to high frequency electromagnetic waves on the one hand and to microwaves on the other. In order to apply high frequency waves, capacitive applicators can be used which consist of placing a product between two parallel electrodes, where the electric field applied is always perpendicular to said electrodes. For continuous treatments, it is possible to use the “tunnel” ovens constituted by a metal body ensuring the shielding of the equipment, with an inlet and an outlet, the electrical coupling always being of capacitive type. For the use of microwaves, multi-mode applicators of “tunnel” type can be used for a continuous application, multi-mode applicators of sealed enclosure type for batch treatment i.e. for each production batch, mono mode rectangular or circular resonator applicators, with ring resonator, or also slow wave devices which can be used for the treatment of materials with low losses or having a low volume in the cavity, in static or continuous mode.

As the radiation also promotes heating of the bitumen/polymer composition to be cross-linked, in the process of the invention, it is necessary to monitor the temperature of the mixture. As the hydrocarbons, in particular the very asphaltenic hydrocarbons such as the bitumen, can crack from a certain temperature, the increase of the temperature will be limited to a temperature less than or equal to 240° C., by acting within a certain limit on the amplitude of the field or by the supply of frigories by related means.

The process according to the invention is advantageously composed of at least one step of mixing the bitumen with the polymer to be cross-linked and at least one step of subjecting said bitumen/polymer mixture without the addition of cross-linking agent to electromagnetic wave radiation. The first step can be carried out in various ways. Thus, it is possible to envisage grinding separately the bitumen and the polymer in the form of granules and/or powder and then mixing them.

In a preferred embodiment for the implementation of this first step, carried out in a standard fashion by a person skilled in the art, the bitumen is heated to at least a temperature equal to 90° C., preferably greater than or equal to 120° C. by any means, then the polymer is introduced in divided form, powder and/or granule form, then dispersed in the bitumen by any means of stirring and/or recirculation of the mixture. For heating the bitumen, standard thermal heating and/or dielectric heating (also called heating by electromagnetic wave radiation or heating by dielectric losses) can be used.

Another parameter necessary for the process according to the invention is the homogenization of the temperature of the bitumen polymer mixture which will preferably be in continuous. In fact, without homogenization, the temperatures within the mixture can be very variable. Moderate thermal heating is applied and a circulation regime promoting the fluidification of the bitumen/polymer mixture is set up, before subjecting said mixture to electromagnetic wave radiation.

In a preferred embodiment of said process according to the invention, the bitumen/polymer mixture is cross-linked in liquid phase at a temperature greater than or equal to 90° C. The use of complementary thermal heating or of means for cooling down the mixture by total or partial recirculation of the mixture undergoing cross-linking during application of the radiation, is not excluded for maintenance of the optimum cross-linking temperature.

For an optimum acceleration of the cross-linking by electromagnetic waves, the bitumen/polymer mixture is cross-linked at a regulated temperature between 120° C. and 220° C. These temperatures allow in particular pumping of the bitumen/polymer compositions by pumps conventionally used in the field of bitumen which makes it possible to envisage to cross-linked these mixtures either by production batches which are stirred continuously, or continuously with total or partial recirculation of the mixture, which is totally or partially cross-linked. Preferably, the bitumen/polymer mixture is cross-linked at a temperature regulated between 140° C. and 200° C., more preferably between 160° C. and 180° C.

Due to the combination of the two steps envisaged, the duration of cross-linking of the polymer in said bitumen/polymer mixture according to the invention is extremely shortened. Thus, compared to a process of cross-linking by thermal heating, the duration of cross-linking is reduced by at least 4 times, even 6 times, the level of the amplitude of the radiation applied making the difference. The polymer can therefore be cross-linked effectively within the bitumen matrix in less than 6 hours, and even in less than 4 hours whereas by thermal heating it is difficult to drop below 24 hours for identical bitumen/polymer mixtures. Preferably, the duration of cross-linking can be less than 2 hours, preferably less than 1 hour and more preferably less than 30 minutes.

Polymer

The process according to the invention implements at least one polymer. This polymer is a polymer based on units comprising unsaturations, in particular double bonds, preferably conjugated double bonds, such as conjugated diene units. It is assumed that the cross-linking of the polymer is facilitated by the presence of these unsaturations.

Preferably, the polymer according to the invention consists of one or more copolymers chosen from the copolymers of aromatic monovinyl hydrocarbon and conjugated diene. The conjugated diene is chosen from those comprising 4 to 8 carbon atoms, such as 1-3 butadiene (butadiene), 2-methyl-1,3-butadiene (isoprene), 2,3-dimethyl-1,3-butadiene, 1,3-pentadiene, 1,2-hexadiene, chloroprene, carboxylated butadiene and/or carboxylated isoprene. Preferably, the conjugated diene is butadiene. The aromatic monovinyl hydrocarbon is chosen from styrene, o-methyl styrene, p-methyl styrene, p-tert-butylstyrene, 2,3 dimethyl-styrene, α-methyl styrene, vinyl naphthalene, vinyl toluene and/or vinyl xylene. Preferably, the monovinyl hydrocarbon is styrene.

Preferably, the polymer according to the invention consists of one or more copolymers chosen from the copolymers of styrene and butadiene. These copolymers of aromatic monovinyl hydrocarbon and conjugated diene, in particular of styrene and butadiene, can be linear and/or star, in diblock, triblock and/or multibranched form. They can also be “random” polymers such as the styrene/butadiene rubber SBR copolymers.

These copolymers of aromatic monovinyl hydrocarbon and conjugated diene, in particular of styrene and butadiene, optionally comprise a random hinge. Preferably the polymer is a diblock or triblock copolymer of aromatic monovinyl hydrocarbon and conjugated diene, in particular a diblock or triblock copolymer of styrene and butadiene. The copolymer of aromatic monovinyl hydrocarbon and conjugated diene, in particular of styrene and butadiene, advantageously has a content by mass of aromatic monovinyl hydrocarbon, in particular of styrene in the range from 5 to 50% by mass, relative to the mass of copolymer, preferably from 20 to 40%. The copolymer of aromatic monovinyl hydrocarbon and conjugated diene, in particular of styrene and butadiene, advantageously has a content by mass of conjugated diene, in particular of butadiene in the range from 50 to 95% by mass, relative to the mass of the copolymer, preferably from 60% to 80%. It is on these conjugated diene units that the thiol derivative will react.

Among these conjugated diene units, a distinction is made between units with 1,4 double bonds originating from the conjugated diene and units with 1,2 double bonds originating from the conjugated diene. By “units with 1,4 double bonds originating from the conjugated diene” is meant the units obtained via a 1,4 addition during polymerization of the conjugated diene. By “units with 1,2 double bonds originating from the conjugated diene” is meant the units obtained via a 1,2 addition during polymerization of the conjugated diene. The result of this 1,2 addition is a so-called “pendant” vinylic double bond. These “pendant” vinylic double bonds are very reactive.

Preferably, the copolymer of aromatic monovinyl hydrocarbon and conjugated diene, in particular of styrene and butadiene, has a content of units with 1,2 double bonds originating from the conjugated diene, in particular when the diene is butadiene, between 5 and 50% by mass, relative to the total mass of the conjugated diene units, in particular butadiene, preferably between 10% and 40%, more preferably between 15% and 30%, even more preferably between 20% and 25%, and even more preferably between 18% and 23%. The polymer according to the invention, in particular the copolymer of aromatic monovinyl hydrocarbon and conjugated diene, in particular of styrene and butadiene, has an average molecular weight M_{w} between 10 000 and 500 000 dalton, preferably between 50 000 and 200 000, more preferably between 80 000 and 150 000, even more preferably between 100 000 and 130 000, and even more preferably between 110 000 and 120 000. The molecular weight of the copolymer is measured by chromatography GPC with a polystyrene standard according to standard ASTM D3536.

The quantity of polymer, and in particular of the copolymer based on aromatic monovinyl hydrocarbon and conjugated diene, implemented in the process is from 0.1% to 0% by mass, with respect to the mass of the bitumen/polymer composition, preferably from 0.5% to 20%, more preferably from 1% to 10%, even more preferably from 2% to 9%, even more preferably from 3% to 5%. Preferably, the relatively high quantities of polymer, i.e. quantities greater than 2% of pal mer can be necessary as bitumen is a material which has low dielectric losses. More preferably, the high quantities of polymer, i.e. quantities greater than 5% of polymer can be necessary because the bitumen is a material which has low dielectric losses. When quantities of polymers greater than 5% are used, for example a quantity of 9% by mass of polymer, with respect to the mass of the bitumen/polymer composition, the bitumen/polymer composition can then be diluted in order to achieve quantities by mass of polymer, less than 5%, of the or er of 3% by mass for example. This dilution is carried out in a bitumen base, optionally the same as that used during the cross-linking or another.

In addition to this polymer, other polymers can be optionally present in the bitumen/polymer composition. They are polymers which can be used in a standard fashion in the field of the bitumen/polymer compositions chosen from the group comprising the terpolymers of alkylenes and/or of mono or polyvinyl aromatic hydrocarbon, the copolymers of mono, polycarboxylate and/or alkylmono, polycarboxylates, the copolymers of alkylene and carboxylic anhydride, the polymers of conjugated dienes and the alkylene/carboxylate/aromatic vinyl terpolymers. They are for example, polybutadienes, polyisoprenes, polyacrylates, polymethacrylates, polychloroprenes, polynorbornenes, polybutenes, polyisobutenes, polyolefins such as polyethylenes, polypropylenes, the copolymers of ethylene and vinyl acetate, the copolymers of ethylene and methyl acrylate, the copolymers of ethylene and butyl acrylate, the copolymers of ethylene and maleic anhydride, the copolymers of ethylene and glycidyl methacrylate, the copolymers of ethylene and glycidyl acrylate, the copolymers of ethylene and propene, the ethylene/propene/diene (EPDM) terpolymers, the acrylonitrile/butadiene/styrene (ABS) terpolymers, the ethylene/alkyl acrylate or methacrylate/acrylate or glycidyl methacrylate terpolymers and in particular the ethylene/methyl acrylate/glycidyl methacrylate terpolymers and the ethylene/alkyl acrylate or methacrylate/maleic anhydride terpolymers and in particular the ethylene/butyl acrylate/maleic anhydride terpolymers. Other polymers such as powdered rubbers originating from tyre recycling and butyl rubbers can also be incorporated in the bitumen.

Bitumen

The bitumen which can be used according to the invention can be a bitumen of different origins. It can be chosen from the bitumen of natural origin, such as those contained in deposits of natural bitumen, natural asphalt or bituminous sands. It can also be a bitumen or a mixture of bitumen originating from the refining of crude oil such as bitumen originating from direct distillation or bitumen originating from vacuum distillation or also blown or semi-blown bitumen, propane or pentane de-asphalting residues, visbreaking residues, these different cuts being alone or in a mixture. The bitumen used can also be bitumen fluxed by the addition of volatile solvents, fluxes originating from oil, carbochemical fluxes and/or fluxes of vegetable origin. It is also possible to use synthetic bitumen also called clear bitumen, pigmentable or colourable bitumen. The bitumen can be a bitumen of naphthenic or paraffinic origin, or a mixture of these two bitumen. The bitumen of paraffinic origin are preferred.

Other Additives to the Bitumen/Polymer Mixtures

In addition to the bitumen and the polymer, the process according to the invention can be applied to bitumen/polymer mixtures containing additives, these additives being optional but commonly added to the bitumen. Certain of these additives are chosen from waxes, resins, oils, adhesiveness dopes and/or mineral or organic acids and derivatives thereof.

Among the oils capable of being added to the bitumen, fluxes can be chosen such as oils based on animal and/or vegetable fats and derivatives thereof or hydrocarbon oils of petroleum origin. The oils of animal and/or vegetable origin and derivatives thereof correspond to triglycerides, diglycerides, monoglycerides of fatty acids, in the acid form and/or totally or partially esterified, resulting from the esterification of the acid functions by a linear or branched alcohol, comprising less than carbon atoms, to fatty acids and esters thereof, alone or in a mixture. There can be mentioned for example the fatty acids in methyl ester form.

Among the waxes of animal, vegetable or hydrocarbon origin, long chain hydrocarbon waxes are preferred, for example polyethylene waxes or Fischer-Trospch waxes. The polyethylene waxes or the Fischer-Trospch waxes can optionally be oxidized. Other waxes called “amides” such as ethylene bis-stearamide can also be added to the bitumen used.

Among the resins, the addition of resins of vegetable origin such as the colophanes is preferred. Among the mineral acids generally added to the bitumen, polyphosphoric acid or diacids, in particular fatty diacids are preferred.

In lesser proportions, adhesiveness dopes and/or surfactants can be added to the bitumen. They are chosen from the derivatives of alkylamines, derivatives of alkyl-polyamines, derivatives of alkylamidopolyamines, derivatives of alkyl amidopolyamines and derivatives of quaternary ammonium salts, alone or in a mixture. The most used are tallow propylene-diamines, tallow amido-amines, quaternary ammoniums obtained by quaternization of tallow propylene-diamines, tallow propylene-polyamines.

Among the usual bitumen additives, the following can be included: the derivatives of sorbitol, the hydrazide derivatives, the derivatives of imidazolidinone type, as well as the derivatives of Tall oil, such as the fatty acids of Tall oil and/or Tall oil pitches originating from its distillation. The scope of the invention will not be exceeded if mixtures of one or more additives are added in combination to the bitumen, such as for example a combination of a Tall Oil pitch and a methyl ester of a mixture of fatty acids. Within the scope of the present invention, the bitumen/polymer mixture to be cross-linked does not comprise mineral fillers or aggregates and is therefore not assimilated into a bituminous mastic or a bituminous mix. The bituminous binder thus obtained by cross-linking according to the process of the invention, will then be able mixed with mineral fillers and/or aggregates in order to provide bituminous mastics or bituminous mixes.

Demonstration of the Cross-Linking

The cross-linking of the bitumen/polymer compositions can be demonstrated by comparing the tensile strength determined according to standard NF EN 13587 of the cross-linked bitumen/polymer mixtures and of the bitumen/polymer mixtures of the same concentration but not cross-linked. The cross-linked bitumen/polymer compositions have a higher tensile strength than the bitumen/polymer compositions that are not cross-linked. A higher tensile strength is reflected in a high elongation at break or maximum elongation (∈ max in %), a high breaking stress or stress at maximum elongation (σ ∈ max in MPa), a high conventional energy at 400% (E 400% in J/cm²) and/or a high total energy (E total in J).

The process according to the invention therefore makes it possible to obtain cross-linked bitumen/polymer compositions having a maximum elongation, according to standard NF EN 13587, greater than or equal to 400%, preferably greater than or equal to 500%, more preferably greater than or equal to 600%, and even more preferably greater than or equal to 700%. The process according to the invention therefore makes it possible to obtain cross-linked bitumen/polymer compositions having a stress at maximum elongation, according to standard NF EN 13587, greater than or equal to 0.4 MPa, preferably greater than or equal to 0.6 MPa, more preferably greater than or equal to 0.8 MPa, and even more preferably greater than or equal to 1.2 MPa. The process according to the invention therefore makes it possible to obtain cross-linked bitumen/polymer compositions having a conventional energy at 400%, according to standard NF EN 13587, greater than or equal to 3 J/cm², preferably greater than or equal to 5 J/cm², more preferably greater than or equal to 10 J/cm², and even more preferably greater than or equal to 15 J/cm². The process according to the invention therefore makes it possible to obtain cross-linked bitumen/polymer compositions having a total energy, according to standard NF EN 13587, greater than or equal to 1 J, preferably greater than or equal to 2 J, more preferably greater than or equal to 4 J, and even more preferably greater than or equal to 5 J.

Use of the Cross-Linked Bitumen/Polymer Compositions

The bitumen/polymer compositions obtained according to the process of the invention can be used as bituminous binders in anhydrous form or in the form of an emulsion. The bitumen/polymer compositions obtained according to the process of the invention can be used directly or in a mixture with other bitumen or other products for road applications in order to produce hot mixes, warm mixes, cold mixes, cold-cast mixes, asphalts or surface dressings and/or in industrial applications in order to produce sealing membranes, membranes or priming coats. In particular the bitumen/polymer compositions make it possible to produce bituminous mixes.

The bituminous mix will advantageously comprise from 1 to 10% by mass of cross-linked bitumen/polymer composition, with respect to the total mass of the mix, preferably from 4 to 8% by mass. The scope of the invention will not be exceeded if a cross-linked bitumen/polymer mixture is combined in the same mix with a mixture that is identical or different in composition, but not cross-linked.

### EXAMPLES

Control bitumen/polymer compositions and bitumen/polymer compositions according to the invention are prepared in order to evaluate and compare their physico-mechanical characteristics. For each of the bitumen/polymer compositions prepared as indicated in Examples 1 to 4, the following characteristics are determined:

penetrability at 25° C. designated P₂₅ ( 1/10 mm) measured according to standard EN 1426,

Ring & Ball temperature designated RBT (° C.) measured according to standard EN 1427,

Pfeiffer index designated IP defined by the following formula:

$$IP = \frac{1952 - 500 \times log ( {P}_{25} ) - 20 \times RBT}{50 \times log ( {P}_{25} ) - RBT - 120}$$

elastic recovery designated ER (%) measured at 25° C. according to standard NF EN 13398,

threshold stress designated σ threshold (MPa), stress at maximum elongation designated σ ∈ max (MPa), threshold elongation designated E threshold (%), maximum elongation designated ∈ max (%), conventional energy of elongation at 400% designated E 400% (J/cm²), total energy designated E total (J), measured according to standard NF EN 13587, tensile testing being carried out at 5° C. with a stretching rate of 100 mm/minute. The results obtained are shown in Tables 1 and 2 below.

### Example 1

### Control

A control bitumen/polymer composition T₁ is prepared in which a sulphur cross-linking agent (vulcanization) is added before cross-linking. 94.87% by mass of a direct distillation bitumen of paraffinic origin with a penetrability of 46 1/10 mm according to standard NF EN 1426 and 5% by mass of a di-block styrene/butadiene SB copolymer with a statistical hinge having a molecular mass equal to 115 000 g·mol⁻¹, 25% by mass of styrene of which 18% by mass is in the form of block and 75% by mass of butadiene, these percentages by mass being expressed with respect to the mass of the copolymer, the butadiene containing 12% by mass of conjugated 1,2 double bond units, are introduced into a reactor maintained at 190° C. and under stirring at 300 r.p.m. The bitumen/polymer mixture contained in the reactor is then maintained at 190° C. under stirring at 300 r.p.m. for 4 hours. Then 0.13% by mass of flowers of sulphur, with respect to the mass of the bitumen/polymer composition is introduced into the reactor. The content of the reactor is maintained at 190° C. under stirring at 300 r.p.m. for 2 hours, then at 180° C. under stirring at 150 r.p.m. for 12 hours.

### Example 2

### Control

A bitumen/polymer composition control T₂ is prepared without the addition of cross-linking agent which is cross-linked thermally. 95% by mass of bitumen of paraffinic origin with a penetrability of 46 1/10 mm measured according to standard EN 1426 and 5% by mass of a di-block styrene/butadiene SB copolymer with a statistical hinge having a molecular mass equal to 129 000 g·mol⁻¹, comprising 33% by mass of styrene, of which 18.9% by mass is in the form of a block and 66% by mass of butadiene, these percentages by mass being expressed with respect to the mass of the copolymer, the butadiene containing 18.5% by mass of conjugated 1,2 double bond units, are introduced into a reactor maintained at 190° C. and under stirring at 300 r.p.m. The bitumen/polymer mixture in the reactor is then maintained at 190° C. under stirring at 300 r.p.m. for 8 hours, then at 190° C. under stirring at 150 r.p.m. until to 24 hours.

TABLE 1

| | Composition T₁ | Composition T₂ |
|---|---|---|
| P₂₅ (1/10 mm) | 45 | 35 |
| RBT (° C.) | 62.0 | 65.8 |
| IP | 1.2 | 1.3 |
| ER (%) | 91 | 81 |
| σ threshold (MPa) | 1.3 | 3.1 |
| σ ε max (Mpa) | 0.9 | 1.3 |
| ε threshold (%) | 11.5 | 11.7 |
| ε max (%) | 700 | 700 |
| E 400% (J/cm²) | 13.4 | 19.0 |
| E total (J) | 3.0 | 4.1 |
| Duration of cross-linking | 14 | 30 |
| (hours) | | |

The bitumen/polymer composition T₁ cross-linked with sulphur has very good consistency characteristics and very good elastomeric properties. However during the preparation of the cross-linked bitumen/polymer composition T₁ with sulphur, releases of H₂S occur. The cross-linked thermally bitumen/polymer composition T₂ also has very good consistency characteristics and very good elastomeric properties, without releases of H₂S with a reaction time of 24 hours.

### Example 3

### According to the Invention

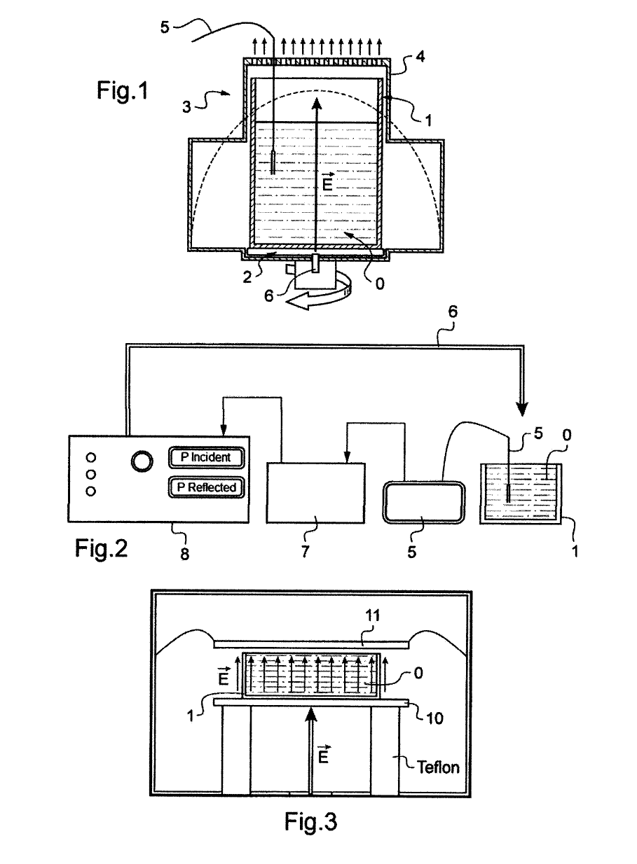

A bitumen/polymer mixture (composition) C₃ is prepared and it is subjected to an electromagnetic field with frequency of 915 MHz (microwaves) and maintained at a temperature of 194° C. for 6 hours. The transfer of energy is carried out using a microwave applicator in a hermetically sealed enclosure, the applicator being represented in FIG. 1. The applicator is connected by a waveguide to a wave generator via an impedance matching structure. The temperature of the bitumen/polymer is maintained at the desired set value (194° C.) using a system equipped with a fibre optic temperature sensor associated with a regulator, the assembly being part of an apparatus developed by the Centre Technique des Industries Aérauliques et Thermiques (CETIAT) as described in FIG. 2.

In FIG. 1, the sample (0) of hot bitumen/polymer to be cross-linked is arranged in a cylindrical quartz container (1) itself placed on a revolving plate (2) in an enclosure (3) of suitable form to avoid any leak of electromagnetic radiation and for compelling the wave to interact with the bitumen/polymer. The hermetically sealed enclosure (3) was built on the basis of a waveguide standard (WR 975) propagating the TE₀₁ mode (6). By placing the container (1) in a zone where the electric field reaches a maximum value, the amplitude of the latter is controlled by acting on the transmitting power of the bitumen/polymer mixture. The enclosure (3) comprises a chimney (4) making it possible to evacuate the bitumen vapours and to introduce a fibre optic thermometer which does not interfere with the electromagnetic field (5) in order to control the temperature of the mixture. The source of the microwaves (6) with a frequency set at 915 MHZ is applied at the centre of the revolving plate (5) below the container (1), the rotation of the plate (2) allowing a homogenization of the distribution of the electromagnetic energy applied to the entire sample. The temperature regulation is carried out using the thermometer (5) marketed by the company FISO (Quebec) connected in FIG. 2 to a temperature regulator (7) which makes it possible, using a 0-10v link, to control the transmitting power of the power generator (8) which supplies the applicator in which the bitumen/polymer is placed.

Preparation of the Bitumen/Polymer Mixture

91% by mass of bitumen of paraffinic origin with a penetrability of 69 1/10 mm measured according to standard EN 1426 and a Ring and Ball temperature measured according to standard EN 1427 of 47.4° C. is introduced into a reactor maintained at 160° C. A high shear grinder of Silverson L5M type is introduced into this reactor. Then, 9% by mass of the copolymer described in Example 2 is added successively. After grinding for 20 minutes, the content of the reactor is maintained at 160° C. under stirring at 400 r.p.m. for 3 hours. A sample of the mixture contained in the reactor is poured into the container (1) in order to be subjected to the microwave treatment for the cross-linking. Specifically, this container (1) is a container with a diameter of 100 mm, and a total height of the order of 200 mm. The quantity of bitumen/polymer composition according to the invention C₃ is such that it fills the container so as to occupy a height corresponding to the height of the waveguide (123 mm).

Microwave Treatment

Once the container (1) containing the bitumen/polymer mixture is placed in the enclosure (3), the microwave generator emitting at 915 MHZ is started. Its transmitting power is regulated using the temperature sensor system, which is a regulator for achieving a maximum temperature of the bitumen/polymer mixture of 200° C. (regulated at 194° C.) for 6 hours.

### Example 4

### According to the Invention

A composition or bitumen/polymer mixture according to the invention C₄ is prepared identically to composition C₃ of Example 3 then the bitumen/polymer composition is subjected to an electromagnetic field with a frequency of 27.12 MHz, and maintained at a temperature of 194° C. for 6 hours.

High Frequency (HF) Treatment

In this example a high frequency applicator of capacitive type developed by the CETIAT is used as shown in FIG. 3. It is connected as in FIG. 2 by a coaxial link (6), via an automatic impedance matching device (8), to a transmitting power generator which can be adjusted from 0 to 600 W (7). The temperature of the bitumen/polymer is maintained at the desired set value (194° C.) using a system equipped with a fibre optic temperature sensor associated with a regulator which controls the power transmission of the generator. The high frequency applicator is an applicator of capacitive type equipped with a fixed electrode (200×250) (10) at the HF potential and an upper mobile electrode (11), at earth potential, making it possible to adjust the inter electrode space using a hydraulic jack (not shown). The distribution of the electric field over the sample which is placed between the two electrodes is considered to be perfectly homogeneous in all the inter electrode space.

The tests relating to the cross-linked bitumen/polymer mixtures corresponding to samples C₃ and C₄ are given in Table 2 below.

TABLE 2

| | Composition C₃ | Composition C₄ |
|---|---|---|
| P₂₅ (1/10 mm) | 57 | 70 |
| RBT (° C.) | 69.8 | 73.4 |
| IP | 3.2 | 4.3 |
| ER (%) | 83 | 86 |
| σ threshold (MPa) | 0.71 | 0.58 |
| σ ε max (MPa) | 0.64 | 0.67 |
| ε threshold (%) | 26.65 | 20.44 |
| ε max (%) | 700 | 700 |
| E 400% (J/cm²) | 13.26 | 9.91 |
| E total (J) | 2.79 | 2.18 |
| Cross-linking time (h) | 6 | 6 |

According to the results of Table 2, the bitumen/polymer mixture compositions C₃ and C₄ have indeed been cross-linked. The values for elastic recovery and the values obtained in the traction test, in particular the maximum elongation, the stress at maximum elongation and the conventional energy at 400% of the compositions C₃ and C₄ are equivalent to those obtained for the control compositions T₁ or T₂, without the release of harmful vapours such as H₂S as with the control T₁ and a shorter reaction time with the control T₂. This proves that the process according to the invention makes it possible to cross-link the bitumen/polymer mixtures without the addition of cross-linking agent, which often generates harmful vapours and in a shorter period of time.

1. A process for the preparation of cross-linked bitumen/polymer compositions without the addition of a cross-linking agent, the process comprising contacting at least one bitumen with at least one polymer, and subjecting a mixture of the bitumen and the polymer to an electromagnetic wave radiation in a high frequency and/or microwave range.

2. The process according to claim 1, wherein the frequencies of the electromagnetic waves are comprised between 1 MHz and 300 GHz.

3. The process according to claim 1, further comprising cross-linking the bitumen/polymer mixture at a temperature less than or equal to 240° C.

4. The process according to claim 1, further comprising cross-linking the bitumen/polymer mixture in a liquid phase at a temperature greater than or equal to 90° C.

5. The process according to claim 1, further comprising cross-linking the bitumen/polymer mixture at a temperature varying from 120° C. to 220° C.

6. The process according to claim 1, further comprising at least one step of mixing the bitumen with the polymer and at least one step of subjecting the mixture to a radiation by electromagnetic waves.

7. The process according to claim 6, further comprising obtaining the bitumen/polymer mixture at ambient temperature by grinding the two components respectively then intimately mixing of them.

8. The process according to claim 6, further comprising heating the bitumen to a temperature at least equal to 90° C., and then the polymer is introduced in divided form into the bitumen.

9. The process according to claim 1, wherein the bitumen/polymer mixture is subjected to an electromagnetic radiation for a duration at most four times less than the cross-linking time by thermal heating for the same bitumen/polymer mixture.

10. The process according to claim 9, wherein the bitumen/polymer mixture is subjected to an electromagnetic radiation for a duration of less than 6 hours.

11. The process according to claim 1, wherein the polymer is a polymer based on units comprising unsaturations.

12. The process according to claim 11, wherein the polymer is chosen from the aromatic monovinyl hydrocarbon and conjugated diene copolymers, the alkylene and/or aromatic mono or polyvinyl hydrocarbon terpolymers, the mono, polycarboxylate and/or alkylmono, polycarboxylate copolymers, the alkylene and carboxylic anhydride copolymers, the conjugated diene polymers and the alkylene/carboxylate/aromatic vinyl terpolymers, these compounds being used alone or in a mixture.

13. The process according to claim 11, wherein the polymer is a polymer based on styrene units and butadiene units, the diene unit content being greater than or equal to 5% by mass, with respect to the total mass of the conjugated diene units.

14. The process according to claim 1, wherein the quantity of polymer is comprised between 0.1% and 30% by mass, with respect to the mass of the bitumen/polymer composition.

15. A cross-linked bitumen/polymer composition comprising at least one bitumen, at least one polymer, no cross-linking agent, and electromagnetic wave radiation in high frequency and/or microwave range causing cross-linking of the bitumen and polymer.

16. The cross-linked bitumen/polymer composition according to claim 15, further comprising aggregates.

17. The cross-linked bitumen/polymer composition according to claim 15, further comprising fillers.

18. (canceled)

19. The cross-linked bitumen/polymer composition according to claim 15, being obtained in a mixture with at least one other bitumen.

20. The cross-linked bitumen/polymer composition of claim 15, wherein the polymer is chosen from the aromatic monovinyl hydrocarbon and conjugated diene copolymers, the alkylene and/or aromatic mono or polyvinyl hydrocarbon terpolymers, the mono, polycarboxylate and/or alkylmono, polycarboxylate copolymers, the alkylene and carboxylic anhydride copolymers, the conjugated diene polymers and the alkylene/carboxylate/aromatic vinyl terpolymers, these compounds being used alone or in a mixture.

21. The cross-linked bitumen/polymer composition of claim 15, wherein the polymer is a polymer based on styrene units and butadiene units, the diene unit content being greater than or equal to 5% by mass, with respect to the total mass of the conjugated diene units.

22. The cross-linked bitumen/polymer composition of claim 15, wherein the quantity of polymer is comprised between 0.1% and 30% by mass, with respect to the mass of the bitumen/polymer composition.

23. The process according to claim 11, wherein the polymer is a polymer based on units comprising double bonds.

24. The process according to claim 23, wherein the polymer is a polymer based on units comprising conjugated double bonds including conjugated diene units.

25. The process according to claim 13, wherein the polymer is a polymer based on styrene units and butadiene units, the diene unit content being greater than 15% by mass, with respect to the total mass of the conjugated diene units.
